(19) United States
(12) Patent Application Publication
(10) Pub. No.: US 2004/0251806 A1
(43) Pub. Date: Dec. 16, 2004

(54) Lapping arragement for a tungsten filament of a light bulb

(76) Inventors: Chin Sung Tsai, Hsin-Pu Town (TW); Tony On, Shenzhen (CN)

Correspondence Address: PROCOPIO, CORY, HARGREAVES & SAVITCH LLP, 530 B STREET, SUITE 2100, SAN DIEGO, CA, 92101, US

(21) Appl. No.: 10/818,064

(22) Filed: Apr. 5, 2004

(30) Foreign Application Priority Data
Jun. 10, 2003 (CN) 0347259.5

(51) Int. Cl. H01J 1/02; H01K 1/18; H01K 1/00; H01K 1/50; H01J 19/42

(52) U.S. Cl. 313/316; 313/272

(57) ABSTRACT

A lapping arrangement for a tungsten filament to prevent the self-contact and short-circuit of the tungsten filament in a light bulb comprising one or more pairs of posts in the form of molybdenum wire with the tungsten filament lapping on the posts. The angle at the lapping posts between a section of the tungsten filament and an adjacent section is equal to or greater than 90°.

### BACKGROUND

1. Field of the Invention

This invention relates to a lapping arrangement for a tungsten filament, and more particularly, to a lapping arrangement for a tungsten filament of a light bulb, which prevents short-circuiting and changing of its brightness when in operation or subject to shock.

2. Related Art

In a conventional light bulb the lapping arrangement for a tungsten filament is generally constructed of at least three supporting posts in the form of molybdenum wire with the tungsten filament lapping on the posts. At the lapping points, the angle between one section of the tungsten filament and its adjacent section is generally less than 60°. When the light bulb is in operation, the tungsten filament is subject to high temperature. As a result, the tungsten filament is likely to become elongated and flexible such that a section of the filament may come into contact with another section. The contact, which can also result from external shock to the light bulb, can cause short-circuit and the change in brightness, thus reducing the service life and the safety of the light bulb.

### SUMMARY

An object of the invention is to provide a lapping arrangement for a tungsten filament of a light bulb, which can prevent the self-contact and short-circuit of the tungsten filament when the filament becomes flexible, elongated under high temperature or is subject to shock. The present invention provides a lapping arrangement for a tungsten filament, which comprises one or more pairs of posts in the form of molybdenum wire with the tungsten filament lapping on the posts. The angle at the lapping posts between a section of the tungsten filament and an adjacent section is equal to or greater than 90°.

### BRIEF DESCRIPTION OF THE DRAWINGS

FIG. 1 schematically shows the arrangement of the invention.

### DETAILED DESCRIPTION

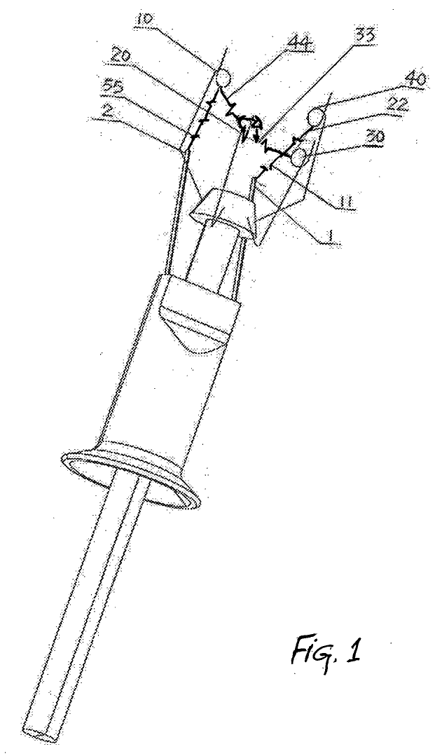

As shown in FIG. 1, the present invention includes four posts in the form of molybdenum wire (10, 20, 30, and 40) and a plurality of tungsten filament sections (11, 22 , 33, 44 , and 55) lapping on the posts. The first aaaaaa section 11, which is connected to a first lead 1, is lapped on a loop at the distal end of the fourth molybdenum post 40. The second section 22 is lapped between the fourth molybdenum post 40 and the third molybdenum post 30. The third section 33 is lapped between the third molybdenum post 30 and the second molybdenum post 20. The fourth section 44 is lapped between second molybdenum post 20 and first molybdenum post 10. The fifth section 55 is lapped between first molybdenum post 10 and the second lead 2.

The angle α between a tungsten section and another adjacent section (sections 33 and 44) or (sections 22 and 33) is equal to or greater than 90°. First molybdenum post 10, second molybdenum post 20 and tungsten filament section 44 may form a teragon arrangement. Similarly, molybdenum post 20, post 30 and tungsten section 33 may also define a teragon relationship. A similar teragon configuration is defined by tungsten filament section 22, section 33 and section 44.

Therefore, the tungsten filament can not contact itself and short-circuit even if it becomes flexible under high temperature or it is shocked.

What is claimed is:

1. A lapping arrangement for tungsten filament of a light bulb, which comprises a plurality of support posts and tungsten filaments being lapped on the support posts to define an angle of at least 90° between at least one section of tungsten filament and its adjacent tungsten section about the support posts.

2. The lapping arrangement according to claim 1, wherein the support posts are constructed of molybdenum.

3. The lapping arrangement according to claim 1, wherein a pair of support posts and a tungsten filament section form a teragon relationship.

4. The lapping arrangement according to claim 1, wherein at least three sections of the tungsten filaments are arranged to define a teragon relationship.
